(19) United States
(12) Patent Application Publication
(10) Pub. No.: US 2012/0193437 A1
(43) Pub. Date: Aug. 2, 2012

(54) WIRELESS THERMOSTAT ADAPTER SYSTEM

(75) Inventors: Robert E. Henry, JR., Gray, TN (US); Daniel Libby, Gray, TN (US); Terry K. Sams, Jonesborough, TN (US)

(73) Assignee: TPI CORPORATION, Johnson City, TN (US)

(21) Appl. No.: 13/017,492

(22) Filed: Jan. 31, 2011

(51) Int. Cl. G05D 23/00

(52) U.S. Cl. 236/51

(57) ABSTRACT

A wireless thermostat adapter system (10) includes a thermostat interface (11) and an HVAC interface (12). A two-way wireless communication is effected between the thermostat interface and the HVAC interface through a conventional RF signal. The thermostat interface also includes an electrical circuit (26) with an antenna (27), a set of six flexible thermostat coupling wires (28) which are coupled to the thermostat, and a short range RF transceiver (29). The HVAC interface includes an electrical circuit 38 which is adapted to be coupled to a HVAC systems (14). The HVAC interface circuit includes an antenna (39) and a set of six HVAC wire terminals (40) which coupled the HVAC interface with the HVAC. The HVAC interface also includes a short range RF transceiver (41) coupled to the antenna (39).

### TECHNICAL FIELD

This invention relates to wireless thermostats, and specifically to wireless thermostat adapter systems.

### BACKGROUND OF THE INVENTION

Thermostats have existed for many years. The basic thermostat typically includes a temperature setting device and an on/off/automatic switch. Recently, programmable thermostats have been designed to include programmable capabilities that include multiple time periods associated with each day and different temperatures (both heating and cooling) associated with each time period. The thermostat then controls a heating and/or cooling system (HVAC system) according to the programmed times and temperatures for each time period throughout the day.

Both the basic thermostat and the programmable thermostat are usually hard wired to the controller of a HVAC system (heating, ventilating, and air-conditioning system) located in another portion of the building or home. The hard wiring of these thermostats means that an electrically conductive set of wires must extend the entire distance between the thermostat and the controller.

To avoid the necessity of running an electrically conductive set of wires throughout a building or home or changing one set of wires for another set of wires during the retrofitting of a thermostat, recently thermostats having RF (radio frequency) capabilities have been developed. These thermostats have an RF transmitter built into the thermostat unit and a corresponding RF receiver mounted to the HVAC system. However, these units are typically expensive. Furthermore, some people who are accustomed to the operation of their present thermostat are reluctant to change to another thermostat to which they are unaccustomed.

Accordingly, it is seen that a need remains for a thermostat adapter that can enable a pre-existing thermostat to be capable of wirelessly controlling an HVAC system. It is to the provision of such therefore that the present invention is primarily directed.

### SUMMARY OF THE INVENTION

In a preferred form of the invention a wireless thermostat adapter systems for use with a thermostat having wiring outputs and an HVAC system having wiring inputs comprises a thermostat interface having a housing, mounting means for mounting the thermostat to the housing, and circuitry for processing an electric signal from the thermostat and wirelessly sending control signals. The circuitry has wiring adapted to be coupled to the thermostat wiring outputs. The system also has an HVAC interface having a housing and circuitry for processing a wireless signal from the thermostat interface circuitry and sending electric control signals through wiring outputs to the HVAC system wiring inputs.

### BRIEF DESCRIPTION OF THE DRAWINGS

FIG. 1 is a partially exploded view of a wireless thermostat adapter system embodying principles of the invention in a preferred form, shown mounted to a conventional thermostat and a conventional HVAC system.

FIG. 2 is a perspective view of the thermostat interface portion of the wireless thermostat adapter system of FIG. 1, shown mounted to a conventional thermostat.

FIG. 3 is a wiring diagram of the thermostat interface portion of the wireless thermostat adapter system of FIG. 1.

FIGS. 4A and 4B are wiring diagrams of the HVAC interface portion of the wireless thermostat adapter system of FIG. 1.

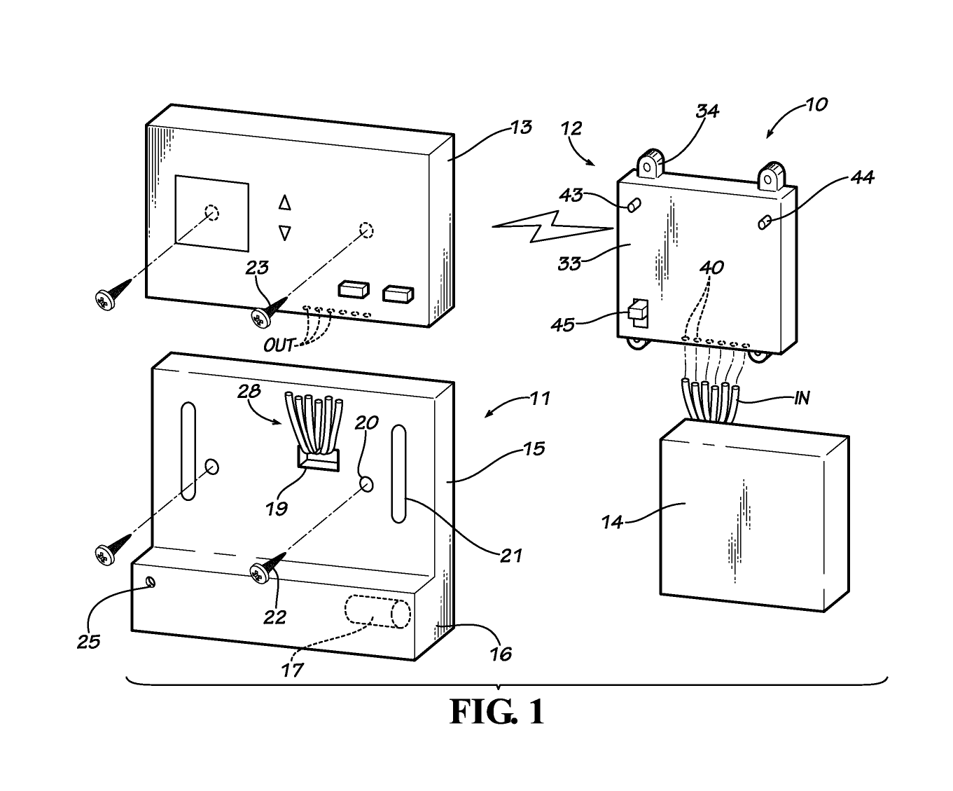

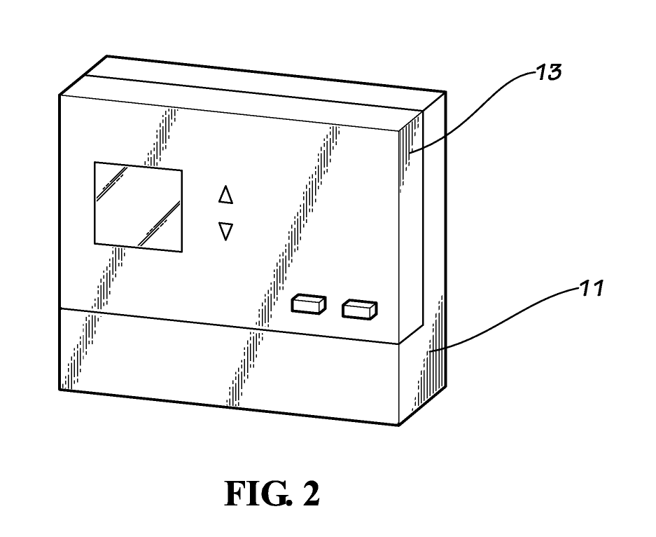

### DETAILED DESCRIPTION

With reference next to the drawings, there is shown a wireless thermostat adapter system 10 embodying principles of the invention in a preferred form. The thermostat adapter system 10 includes a thermostat component or interface 11 and an HVAC component or interface 12. A two-way wireless communication is effected between the thermostat interface 11 and the HVAC interface through a conventional RF signal. The HVAC system 14 may be any conventionally know system which may include a heating unit and/or a cooling unit. The HVAC system typically includes a set of wires or wire inputs IN that are typically hard wired to electrical wiring passing through the structural walls to the thermostat 13. The thermostat 13 may be any conventionally know basic thermostat which may typically include a temperature selector and an on/off/auto switch or a programmable thermostat having a display, up and down keys, and other manually actuated input keys. The programmable thermostat may include many different computer architectures, but generally requires a temperature sensor, a microprocessor or central processing unit (CPU) having a permanent memory such as a read only memory (ROM) for storing the schedule program set or instructions for operation and control of the thermostat, a working memory or random access memory (RAM) that retains or receives at least the particular schedule program set for that day, and a clock. The thermostat typically includes a set of outputs OUT such as wiring terminals or contacts that are coupled to the hard wires extending to the conventional HVAC system.

The thermostat interface 11 has a housing which is separate, removable, or independent from the thermostat, i.e., the thermostat interface is a separate component from the thermostat. The thermostat interface 11 includes a rear mounting wall 15 and a battery compartment 16 which houses one or more batteries 17. The rear mounting wall 15 includes a central wire access port 19, a pair of wall mounting holes 20, and a pair of thermostat mounting slots 21. A pair of mounting screws 22 may be passed through the wall mounting holes 20 and into the adjacent wall if it is desired to fix the location of the thermostat interface 11 to the wall. A second pair of mounting screws 23 are passed through the rear plate of the thermostat 13 and into the elongated mounting slots 21 to fix or couple the thermostat 13 to the thermostat interface 11. The elongated slots allow for variances in the arrangement of the mounting holes of the thermostat. Alternatively, other means of mounting or coupling the thermostat 13 to the thermostat interface 11 may be used, such as double sided tape, an adhesive, a fastener, a strap, a bracket, a clamp or other conventionally known coupling means.

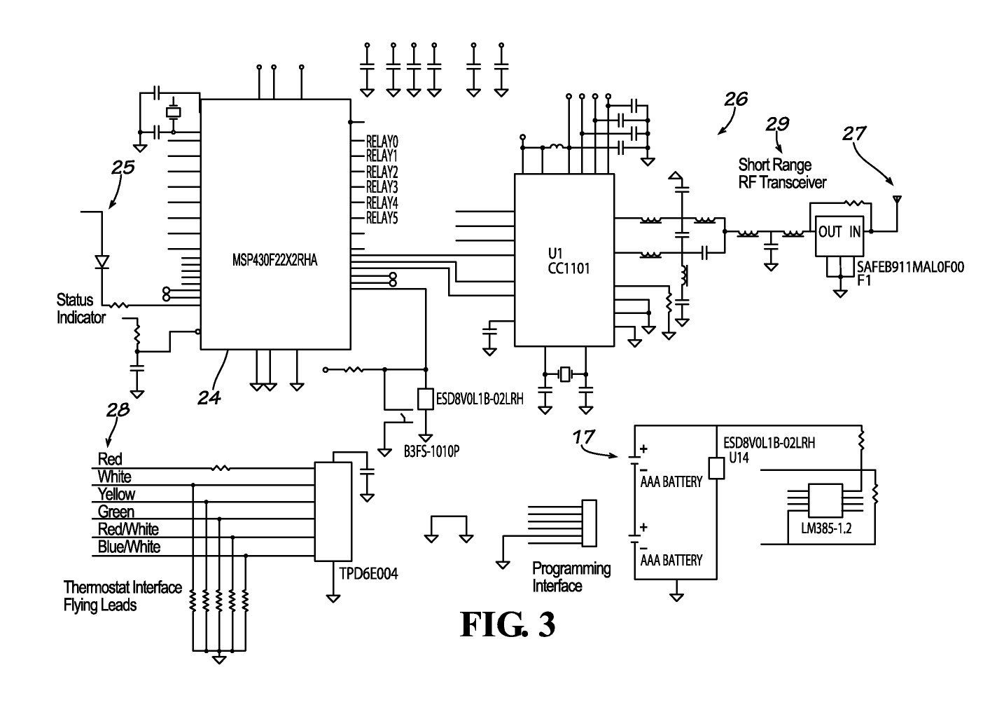

The thermostat interface 11 also includes an electrical circuit 26 which is adapted to be coupled to most conventionally know thermostats. The electrical circuit is powered by batteries 17 and includes an LED light 25, an antenna 27 and a set of six flexible thermostat coupling wires 28. The thermostat coupling wires 28 include a first wire labeled BLUE/WHITE, a second wire labeled RED/WHITE, a third wire labeled GREEN, a fourth wire labeled YELLOW, a fifth wire labeled WHITE, and a sixth wire labeled RED. The electrical circuit 26 is controlled by a Texas Instrument mixed signal micro-controller 24 model number MSP430F22X2RHA and includes a short range RF transceiver 29 coupled to the antenna 27. The complete circuit diagram of the thermostat interface 11 is shown in FIG. 3.

The set of six thermostat coupling wires 28 is coupled to the conventional thermostat 13 in the same manner prescribed for hard wiring the thermostat to the conventional electrical hard wiring of a building, i.e., if the conventional thermostat calls for the red wire of a building hard wire to be coupled to a first port, terminal, or contact of the thermostat then the red wire of the thermostat interface is also coupled to the first port or contact of the thermostat. Table 1 below shows well known thermostat types or models and their corresponding wiring configurations. It should be understood that different thermostats associated with difference types of HVAC systems 14 utilize different numbers of wires. For example, as shown in Table 1, a two wire heater (2 Wire Heat) may only use the RED and WHITE wires (two wires), while a two stage heater and two stage cooling system (2Stg Ht 2 Stg Cl) utilizes all six wires: RED, WHITE, YELLOW, GREEN, RED/WHITE and BLUE/WHITE. Thus, the present thermostat interface may be coupled to any of these types of thermostats/systems with only the selection of the wires possibly being different.

TABLE 1

| | | | | | | | 2 Stg | |
|---|---|---|---|---|---|---|---|---|
| | 2 | 3 | 4 | | 2-4 | 2-4 | Ht | |
| | Wire | Wire | Wire | Heat | Stg | Stg | 2 Stg | |
| | Heat | Cool | H/C | Pump | Heat | Cool | Cl | Zone |
| Red | R | R | R | R | R | R | R | R |
| White | W | | W | W2 | W1 | Y1 | W1 | W |
| Yellow | | Y | Y | Y1 | W2 | Y2 | Y | Y |
| Green | | G | G | G | G | G | G | |
| Red/White | | | | B or O | W3 | Y3 | W2 | |
| Blue/White | | | | E | W4 | Y4 | Y2 | |

Once the thermostat interface is wired to the conventional thermostat the normal operation of the thermostat, i.e., thermostat produced signals, are relayed through the set of six thermostat coupling wires 28 and ultimately transmitted by transceiver 29 as an RF signal to the HVAC interface 12.

The HVAC interface 12 includes a housing 33 having mounting lugs 34 through which mounting screws 35 may pass to secure the HVAC interface 12 to a support surface closely adjacent to the HVAC system 14. The HVAC interface 12 is separate, independent, or removable from the HVAC system. The HVAC interface 12 includes an electrical circuit 38 which is adapted to be coupled to most conventionally know HVAC systems 14 which typically includes a heating system and a cooling system. The electrical circuit 38 receives power from the HVAC system, or alternatively, it may be coupled to a separate 24 volt AC transformer if necessary.

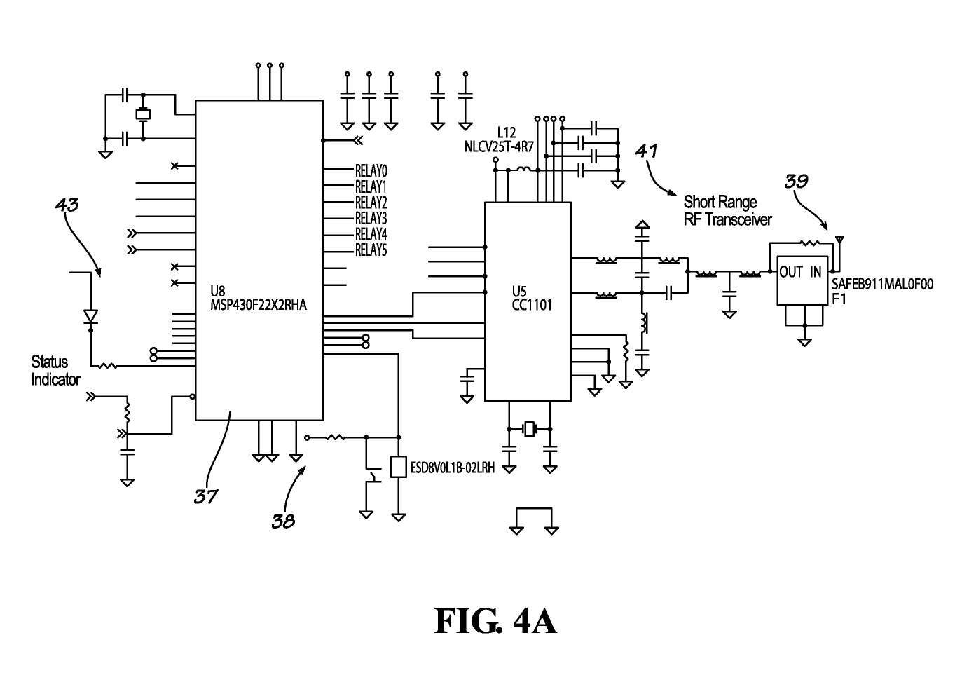

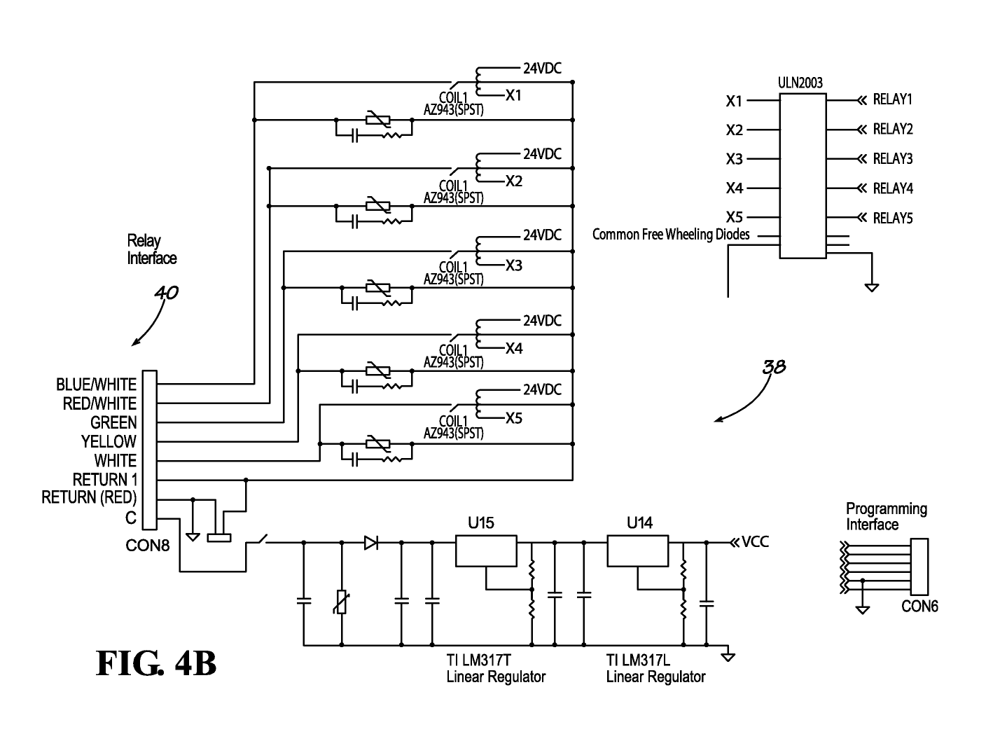

The HVAC interface circuit 38 includes an antenna 39 and a set of six HVAC wire terminals 40 which include a first wire terminal labeled BLUE/WHITE, a second wire terminal labeled RED/WHITE, a third wire terminal labeled GREEN, a fourth wire terminal labeled YELLOW, a fifth wire terminal labeled RETURN 1, and a sixth wire terminal labeled RETURN (RED). The electric circuit 38 is controlled by a Texas Instrument mixed signal micro-controller 37 model number MSP430F22X2RHA and includes a short range RF transceiver 41 coupled to the antenna 39. The complete circuit diagram of the HVAC interface 12 is shown in FIGS. 4A and 4B. It is important to note that the connection of the wiring inputs (set of six thermostat coupling wires 28) of the thermostat interface must match the connection of the set of six HVAC wire terminals 40 (wiring) of the HVAC interface. Table 2 shows the wiring of the HVAC interface with the most commonly available HVAC systems 14.

TABLE 2

| | 2 | 3 | | | | | | |
|---|---|---|---|---|---|---|---|---|
| | Wire | Wire | 4 Wire | Heat | 2-4 Stg | 2-4 Stg | 2 Stg Ht | |
| | Heat | Cool | H/C | Pump | Heat | Cool | 2 Stg Cl | Zone |
| C | C | C | C | C | C | C | C | C |
| R | R | R | R | R | R | R | R | R |
| R1 | R1 | R1 | R1 | R1 | R1 | R1 | R1 | R1 |
| 1 | W | | W | W2 | W1 | Y1 | W1 | W |
| 2 | | Y | Y | Y1 | W2 | Y2 | Y1 | Y |
| 3 | | G | G | G | G | G | G | |
| 4 | | | | B or O | W3 | Y3 | W2 | |
| 5 | | | | E | W4 | Y4 | Y2 | |

Once the HVAC interface 12 is wired to the conventional HVAC system 14, the HVAC interface produces electrical signals which are relayed through the set of six HVAC wire terminals 40 and HVAC system wiring extending from the HVAC system 14.

The HVAC interface 12 also includes an LED light indicator 43, a link button 44, and an on/off switch 45. The LED light indicator 43 is utilized to provide operational status of the HVAC interface 12, such as showing the lost of communication with the thermostat interface 11, a low battery condition, and a powering of the HVAC interface. The link button 44 is utilized to “sync” the HVAC interface 12 with the thermostat interface 11 in the event that the factory set linking has been corrupted or otherwise become inoperable. The on/off switch 45 is utilized to power on or off the HVAC interface.

In use, the thermostat 13 coupled to the thermostat interface 11 operates in a normal manner monitoring the ambient temperature. Should the thermostat 13 sense a temperature below the threshold (set) temperature while in a “heat” mode or above the threshold (set) temperature while in a “cool” mode, the thermostat 13 produces an electronic signal to actuate the appropriate component of the HVAC system (heater with a heat mode and air conditioner with a cool mode). The thermostat electronic signal is relayed to the thermostat interface 11 through the set of six thermostat coupling wires 28 (although not all six wires may be utilized depending on the type of HVAC system utilized). The thermostat interface electric circuit 26 then converts the electronic signal to produces a corresponding RF signal which is transmitted wirelessly through the thermostat interface transceiver 29 and antenna 27 to the HVAC interface 12.

Once the HVAC interface 12 receives the RF signal from the thermostat interface 11, through the HVAC interface electrical circuit 38 and antenna 39, the signal is converted back to a corresponding electronic signal and relayed through the set of six HVAC wire terminals 40 and corresponding wires of the HVAC system 14. It should be understood that the electronic signals produced by the thermostat 13 are the same as those received at the HVAC system 14. Once the thermostat senses an ambient temperature within an acceptable range of temperatures, typically a few degrees from the threshold temperature, the thermostat sends an electrical signal to stop operation of the HVAC system. The electrical signal is again transferred to the thermostat interface where it is then wirelessly transmitted to the HVAC interface, and finally to the HVAC system.

As such, the wireless thermostat adapter systems 10 of the present invention may be retro-fitted to an existing thermostat 13 and HVAC system 14 without having to install new hard wires therebetween. This also aids in being able to change the thermostat system in the event of a change in the HVAC system type, which may necessitate wiring of a different configuration or number of corresponding wires.

It should be understood that if desired the wall mounting screws may be eliminated so that the thermostat and thermostat interface may be made portable and therefore placed anywhere throughout a room or in a different room altogether.

As used herein the transceiver and antenna of either the thermostat interface or the HVAC interface may be referred to collectively as a transceiver.

It thus is seen that a thermostat is now provided which overcomes problems with those of the prior art. While this invention has been described in detail with particular references to the preferred embodiments thereof, it should be understood that many modifications, additions and deletions, in addition to those expressly recited, may be made thereto without departure from the spirit and scope of the invention as described by the following claims.

1. A wireless thermostat adapter systems for use with a thermostat having wiring outputs and an HVAC system having wiring inputs comprising:
a thermostat interface having a housing, mounting means for mounting the thermostat to said housing, and circuitry for processing an electric signal from the thermostat and wirelessly sending control signals, said circuitry having wiring adapted to be coupled to the thermostat wiring outputs; and
an HVAC interface having a housing and circuitry for processing a wireless signal from said thermostat interface circuitry and sending electric control signals through wiring outputs to the HVAC system wiring inputs.

2. The wireless thermostat adapter system of claim 1 wherein said thermostat interface mounting means includes at least one screw passing through a portion of the thermostat and into said thermostat interface housing.

3. The wireless thermostat adapter system of claim 2 wherein said thermostat interface mounting means further includes at least one elongated slot configured to threadably receive said at least one screw.

4. The wireless thermostat adapter system of claim 1 wherein said thermostat interface circuitry includes a set of flexible wires adapted to be coupled to the thermostat wiring outputs.

5. A wireless thermostat system comprising:
a thermostat having a plurality of wire contacts;
a thermostat interface removably coupled to said thermostat, said thermostat interface including a plurality of coupling wires adapted to be coupled to said thermostat contacts, an electric circuit adapted to process electrical signals, and a wireless transmitted coupled to said electric circuit;
an HVAC system having a plurality of input wires; and
an HVAC interface having a plurality of wiring couplers adapted to mate with said HVAC system input wires, said HVAC interface also having a wireless receiver which is adapted to receive a wireless signal from said thermostat interface transmitter, and an electric circuit adapted to process the received wireless signal and produce an electrical signal to said HVAC system input wires.

6. The wireless thermostat system of claim 5 further comprising coupling means for coupling said thermostat interface with said thermostat.

7. The wireless thermostat system of claim 6 wherein said thermostat interface coupling means includes at least one screw passing through a portion of the thermostat and into said thermostat interface.

8. The wireless thermostat system of claim 7 wherein said thermostat interface coupling means further includes a housing having at least one elongated slot configured to threadably receive said at least one screw.

9. The wireless thermostat system of claim 5 wherein said thermostat interface electric circuit includes a set of flexible wires adapted to be coupled to said thermostat.

10. A wireless thermostat adapter system for use with a thermostat and an HVAC system comprising:
a thermostat interface having a housing independent from the thermostat, said thermostat interface having a plurality of coupling wires adapted to be coupled to said thermostat, a thermostat processing circuit coupled to said plurality of coupling wires to process electrical signals received from the thermostat through said plurality of coupling wires, and a wireless signal transmitted coupled to said thermostat interface processing circuit to transmit wireless signals received from said thermostat interface processing circuit, and
an HVAC interface having a wireless receiver to receive wireless signals from the said thermostat interface wireless signal transmitter, an HVAC processing circuit coupled to said HVAC interface wireless receiver and to a plurality of wiring coupled adapted to be coupled to the HVAC system.

11. The wireless thermostat adapter system of claim 10 further comprising coupling means for coupling said thermostat interface with the thermostat.

12. The wireless thermostat adapter system of claim 11 wherein said thermostat interface coupling means includes at least one screw passing through a portion of the thermostat and into said thermostat interface.

13. The wireless thermostat adapter system of claim 12 wherein said thermostat interface coupling means further includes a housing having at least one elongated slot configured to threadably receive said at least one screw.

14. The wireless thermostat adapter system of claim 10 wherein said thermostat interface processing circuit includes a set of flexible wires adapted to be coupled to the thermostat.
